(19) United States
(12) Patent Application Publication
(10) Pub. No.: US 2005/0213473 A1
(43) Pub. Date: Sep. 29, 2005

(54) Optical element and optical pickup device having the same

(75) Inventors: Teruhiko Itoh, Tokyo (JP); Toshiyuki Kojima, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/090,262

(22) Filed: Mar. 28, 2005

(30) Foreign Application Priority Data
Mar. 29, 2004 (JP) 2004-094548

(51) Int. Cl. G11B 7/135

(52) U.S. Cl. 369/112.23

(57) ABSTRACT

An optical element of this invention includes a lens portion serving as an optical function surface and a flange portion whose outer periphery is formed rectangularly at the periphery of the lens portion. The optical element is molded by injecting a resin from a resin injection port located at a position corresponding to a corner of the flange portion in a mold. There is also provided an optical element wherein a cutting portion of a resin injected from a resin injection port of a mold which molds the optical element is formed at one corner of the flange portion. There is further provided an optical pickup device using the optical axis as a collimator lens.

This application is based on and claims priority under 35 U.S.C. §119 from the Japanese Patent Application No. 2004-094548 filed in Japan on Mar. 29, 2004, at least entire content of which is incorporated herein by reference.

### TECHNOLOGICAL FIELD

The present invention relates to an optical element used in an optical pickup device which records and/or reads (reproduces) information on/from an information recording medium and, more particularly, to an optical element suitable for a compact optical pickup device.

### TECHNOLOGICAL BACKGROUND

Conventionally, a recording/reproducing apparatus using an optical disk serving as a recording medium in a computer or audiovisual apparatus has been commercially available. In such a recording/reproducing apparatus, an optical pickup device records or reproduces (reads) information on or from an optical disk. This optical pickup device uses a large number of optical elements.

Demand has arisen for a more compact optical pickup device for a more compact recording/reproducing apparatus. Along with this demand, various shapes of optical elements have been proposed. For example, a compact optical pickup lens or optical pickup unit with a shape which facilitates the manufacture, assembly, and adjustment is disclosed, in which a relationship between an almost circular lens portion and a support portion formed integrally with the lens portion is defined (e.g., Japanese Unexamined Patent Publication No. 2003-43349). In FIG. 8 of this patent reference, a support portion is rectangular, and a lens portion is disposed at the center of the support portion.

FIG. 6 is a schematic perspective view showing a layout of a conventional optical pickup device. Referring to FIG. 6, reference numeral 51 denotes a laser diode; 52, a beam splitter; 53, a collimator lens; 54, a reflecting mirror; 55, an objective lens; and 56, a light-receiving element. Reference symbol F denotes a focal plane of the objective lens. The recording surface of an optical disk serving as an information recording medium is placed on this focal plane.

In the optical pickup device shown in FIG. 6, light having a predetermined wavelength is oscillated from the laser diode 51, passes through the beam splitter 52, and is collimated by the collimator lens 53. The collimated light is deflected by the reflecting mirror 54 and focused by the objective lens 55 on the information recording medium located at the position of the focal plane F. The focused light beam is reflected by the information recording medium, passes through the objective lens 55, reflecting mirror 54, and collimator lens 53, and is then deflected by the beam splitter 52. The deflected beam strikes the light-receiving element 56. The light-receiving element 56 detects the focal state of the beam, focused by the objective lens 55, on the information recording medium. So-called feedback control which moves the objective lens along the optical axis is performed by this detection result.

An actuator using a magnet and coil is generally used to move the objective lens 55 along the optical axis (Y direction in FIG. 6) and the tracking direction (X direction in FIG. 6). In order to make this optical pickup device compact due to the above demand, an actuator 57 may be disposed above the collimator lens 53, as indicated by a dotted line. To meet this demand, the outer peripheral shape of the collimator lens 53 must be made compact so as not to interfere with the actuator 57. At this time, as the outer shape of the lens, the rectangular support portion described in Japanese Unexamined Patent Publication No. 2003-43349 is suitable for the collimator lens 53.

High precision is required for a lens surface formed on the collimator lens 53. Particularly, higher surface precision is required in the X direction of the collimator lens 53 in correspondence with the X direction along which the objective lens 55 moves in tracking. When an optical element having a rectangular flange portion is molded with a resin, the surface precision corresponding to the X direction of the collimator lens 53 is adversely affected depending on the position of a resin injection port.

### SUMMARY OF THE INVENTION

The present invention has been made in consideration of the conventional problems described above, and has as its object to provide an optical element used in an optical pickup device, which ensures surface precision required for a lens portion while keeping the shape of the outer periphery of the optical element compact, and a compact optical pickup device having this optical element.

In order to achieve the above object according to the first aspect of the present invention, there is provided an optical element used for an optical pickup device which emits light onto an information recording medium to record and/or reproduce information, comprising a lens portion serving as an optical function surface, and a flange portion whose outer periphery is substantially rectangularly formed in at least a peripheral portion of the lens portion at a sight in the direction of an optical axis, wherein the optical element is molded by injecting a resin from a resin injection port located at a position corresponding to a corner of the flange portion in a mold.

According to the second aspect of the present invention, there is provided an optical element used for an optical pickup device which emits light onto an information recording medium to record and/or reproduce information, comprising a lens portion serving as an optical function surface, and a flange portion whose outer periphery is substantially rectangularly formed in at least a peripheral portion of the lens portion at a sight in the direction of an optical axis, wherein a cutting portion of a resin injected from a resin injection port of a mold which molds the optical element is formed at one corner of the flange portion.

According to the third or fourth aspect of the present invention, there is provided an optical element according to the first or second aspect, wherein the mold which forms the optical element comprises an air vent at least at a position diametrically opposite to the resin injection port.

According to the fifth or sixth aspect of the present invention, there is provided an optical element according to the third or fourth aspect, wherein the optical element is molded in the mold whose resin injection port is located at a position of a corner farthest from an optical axis of the optical element so as to locate the optical axis of the optical element at a position different from a central portion of the outer peripheral shape of the flange portion.

According to the seventh or eighth aspect of the present invention, there is provided an optical element according to the first or second aspect, wherein a front surface shape of the lens portion is formed to be different from a circle, and the flange portion is formed at a minor-axis portion of the lens portion.

According to the ninth or 10th aspect of the present invention, there is provided an optical pickup device comprising an optical element according to the first or second aspect.

According to the 11th or 12th aspect of the present invention, there is provided an optical pickup device according to the ninth or 10th aspect, wherein the optical element is used as a collimator lens.

According to the 13th aspect of the present invention, there is provided an optical used for an optical pickup device which emits light onto an information recording medium to record and/or reproduce information, comprising a lens portion serving as an optical function surface, and a flange portion whose outer periphery is formed in at least a peripheral portion of the lens portion at a sight in the direction of an optical axis, an outer peripheral shape of said flange portion at a sight in the direction of an optical axis having at least a first linear portion and a second linear portion perpendicular to the first linear portion, wherein the optical element is molded by injecting a resin from a position corresponding to a portion where the first and second linear portions cross each other.

According to the 14th aspect of the present invention, there is provided an optical used for an optical pickup device which emits light onto an information recording medium to record and/or reproduce information, comprising a lens portion serving as an optical function surface, and a flange portion whose outer periphery is formed in at least a peripheral portion of the lens portion, an outer peripheral shape of the flange portion at a sight in the direction of an optical axis having at least a first side extending in a first direction and a second side extending in a second direction and perpendicular to the first side, wherein the optical element is molded by injecting a resin from a position corresponding to a portion where the first and second sides cross each other.

As can be apparent from the above aspects, the optical element according to the present invention is molded by injecting a resin from the resin injection port located at a position corresponding to the corner of the flange portion. The optical element, therefore, assures surface precision required for the lens portion although the outer peripheral shape is made compact.

The cutting portion which cuts the resin injected from the resin injection port is formed at one corner of the flange portion. Even if a crack or distortion occurs in the molded optical element at the time of cutting the molded optical element, the cutting portion is spaced apart from the lens surface, thereby minimizing the probability of occurrence of the defect by the crack or distortion.

The optical element is preferably molded using a mold having an air vent at a position diametrically opposite to the resin injection port. This makes it possible for the injected resin to flow smoothly and improve the surface precision required for an effective optical surface.

When the optical axis of the optical element is located at a position different from the central portion for the outer periphery of the flange portion, the resin injection port is located at a corner portion farthest from the optical axis of the optical element. This makes it possible to obtain an optical element which ensures the surface precision required for the lens portion while the outer peripheral shape of the optical element is kept compact.

When the front shape of the lens portion is different from a circle, a flange portion is formed at the minor-axis portion of the lens portion. Even if a mold which forms the lens portion is shifted by an amount corresponding to a clearance in the mold or a mold is attached while being rotated about the optical axis, the molded lens portion does not project from the flange portion.

When an optical pickup device comprises this optical element, the optical pickup device can be made compact without interfering with the layout of the actuator.

In addition, when an optical pickup device comprises this optical element as a collimator lens, a compact collimator lens whose surface precision of an effective optical surface can be ensured can be obtained. At the same time, the optical pickup device can be made compact without interfering with the layout of the actuator.

The above and many other objects, features and advantages of the present invention will become manifest to those skilled in the art upon making reference to the following detailed description and accompanying drawings in which preferred embodiments incorporating the principle of the present invention are shown by way of the illustrative examples.

### BRIEF DESCRIPTION OF THE DRAWINGS

FIGS. 1A, 1B and 1C show an optical element according to the first embodiment of the present invention, in which FIG. 1A is a plan view, FIG. 1B is a sectional view taken along the line IB-IB in FIG. 1A, and FIG. 1C is a plan view showing an optical element according to a modification of the first embodiment shown in FIG. 1A;

FIG. 2 is a plan view showing an optical element according to the second embodiment of the present invention;

FIG. 3 is a plan view showing an optical element according to the third embodiment of the present invention;

FIG. 4 is a plan view showing an optical element according to the third embodiment of the present invention;

FIG. 5 is a sectional view taken along the line V-V in FIG. 3 in order to illustrate a mold which molds the optical element shown in FIG. 3; and

FIG. 6 is a schematic perspective view showing a layout of a conventional optical pickup device.

### DETAILED DESCRIPTION OF THE PREFERRED EMBODIMENTS

Several preferred embodiments of the present invention will be described in detail with reference to the accompanying drawings. The present invention, however, is not limited to these embodiments.

In the following description, a surface which is actually used and through which a necessary light beam is transmitted is called an effective optical surface. An optical function surface having an optical function and including the effective optical surface is called a lens portion. A portion formed on the periphery of the lens portion and excluding the lens portion is called a flange portion.

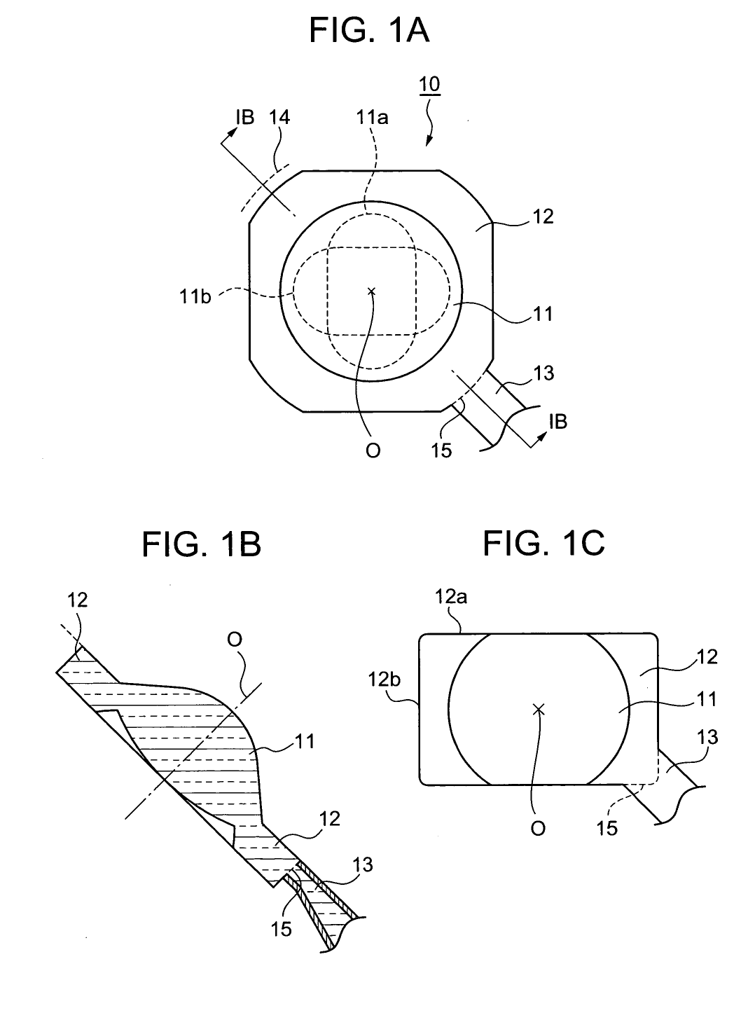

FIGS. 1A and 1B are a plan view showing an optical element according to the first embodiment of the present invention and a sectional view taken along the line IB-IB in FIG. 1A, respectively.

Referring to FIGS. 1A and 1B, an optical element 10 has a lens portion 11 having an optical axis O and a rectangular flange 12 formed on the periphery of the lens portion 11. The center of the outer peripheral shape of the flange portion 12 is nearly aligned with the optical axis O.

The optical element 10 is used as the collimator lens 53 in the optical pickup device shown in FIG. 6. The optical element 10 is disposed such that the X direction in FIG. 6 is made parallel to the straight portions forming the outer periphery of the flange portion. In the optical element 10, a region 11a or 11b surrounded by a dotted ellipse and including an area where the objective lens 55 shown in FIG. 6 moves in the tracking direction (X direction in FIG. 6) is used as the effective optical surface.

The optical element 10 is formed by injection molding using a resin material. A resin injection port (to be referred to as a gate hereinafter) 13 is located at a corner portion of the flange portion, as shown in FIG. 1A. The optical element 10 is molded using the resin having a degassing air vent at a position (position 14 in FIG. 1A) diametrically opposite to the gate 13. Note that air vents may be formed at the two remaining corners, as needed, in addition to the vent hole diametrically opposite to the gate 13.

After the molded optical element is removed from the mold, the gate 13 is cut around a dotted line 15, so that the cutting portion is formed to obtain the optical element 10 having the rectangular flange portion 12.

Since the gate 13 is located at the corner of the flange portion 12 of the optical element 10 having the rectangular flange portion 12 formed on the periphery of the lens portion 11, the gate is located at the position farthest from the optical axis O. The resin is injected from the oblique direction with respect to the longitudinal direction of the region 11a or 11b used as the effective optical surface. This makes it possible to obtain an optical element which ensures the surface precision required for the effective optical surface. In addition, even if a crack or distortion occurs at the time of cutting the gate, the gate is located away from the lens portion, thereby minimizing the probability of occurrence of the defect by the crack or distortion.

The air vent is located at the position diametrically opposite to the gate. This makes it possible for the injected resin to flow smoothly and improve the surface precision required for the effective optical surface.

The present invention makes an offer of not only the foregoing first embodiment of the optical element, as shown in FIG. 1A, in which the flange portion is formed around the periphery of the lens portion, but also an optical element, as a modification of the first embodiment, in which the flange portion is formed at a portion of the periphery of the lens portion as shown in FIG. 1C.

Now, an outer peripheral shape of the lens portion, at a sight in the direction of an optical axis, in the optical element of the present invention can be prescribed as follows. Namely, as shown in FIG. 1C, the outer peripheral shape has at least a first side 12a extending in the first direction and a second side 12b extending in the second direction perpendicular to the first side, in which the first side extending in the first direction occupies the longest portion in the outer peripheral shape of the lens portion. But, the first and second sides are not limited to be linear, but allow to be curved also.

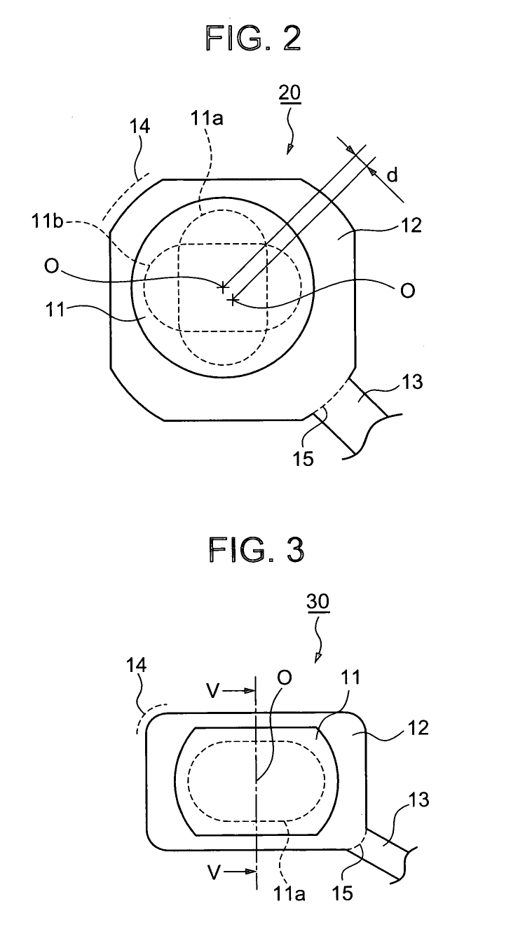

FIG. 2 is a plan view showing an optical element according to the second embodiment of the present invention. Note that the same parts as in the first embodiment denote the same or equivalent function portions in order to prevent a repetitive description.

An optical element 20 shown in FIG. 2 is different from the optical element 10 shown in FIG. 1A in that a center S of the outer periphery formed by a flange portion 12 is shifted from an optical axis O of a lens portion 11 by a predetermined distance (i.e., a distance d in FIG. 2).

In the shape such as that of the optical element 20 shown in FIG. 2, a gate 13 is located at one of the corners of the flange portion 12, which is farthest from the optical axis O. A degassing air vent is located at a position diametrically opposite to the gate 13 in the same manner as described above. Air vents may be formed at two remaining corners, as needed, in addition to the air vent diametrically opposite to the gate 13.

Even in the optical element 20 in which the center S of the outer periphery formed by the flange portion 12 is shifted from the optical axis O of the lens portion 11, the gate is located at the corner farthest from the optical axis O. This makes it possible to obtain an optical element which ensures the surface precision required for the effective optical surface regardless of a small shape of the outer periphery. At the same time, when the air vent is located at the position diametrically opposite to the gate, the surface precision required for the effective optical surface can further be improved.

The gate is located at the position farthest from the lens portion. Even if a crack or distortion occurs at the time of cutting the gate, the gate is located away from the lens surface, thereby minimizing the probability of occurrence of the defect by the crack or distortion.

FIG. 3 is a plan view showing an optical element according to the third embodiment of the present invention. The shape of the upper surface of a lens portion is different from a circle.

Referring to FIG. 3, an optical element 30 has a lens portion 11 having an upper surface shape different from a circle and a rectangular flange portion 12 formed at the periphery of the lens portion 11. The center of the flange portion 12 serving as the outer peripery is nearly aligned with the optical axis O.

The optical element 30 is used as the collimator lens of the optical pickup device shown in FIG. 6. The optical element 30 is disposed such that the X direction in FIG. 6 is made parallel to the straight portions forming part of the outer periphery of the flange portion 12. In the optical element 10, a region 11a surrounded by a dotted ellipse and including an area where the objective lens shown in FIG. 6 moves in the tracking direction (X direction) is used as the effective optical surface.

The optical element 30 shown in FIG. 3 is molded using a resin material. A gate 13 is formed at a corner of the flange portion, as shown in FIG. 3. The optical element 30 is molded by a mold having a degassing air vent at a position (position 14 in FIG. 3) diametrically opposite to the gate 13. Note that air vents may be formed at the two remaining corners, as needed, in addition to the vent hole diametrically opposite to the gate 13.

Even in the optical element having the outer peripheral shape shown in FIG. 3, since the gate 13 is located at the corner of the flange portion 12, the gate can be located at the position farthest from the optical axis O. The resin is injected from the oblique direction with respect to the longitudinal direction of the region 11a used as the effective optical surface. This makes it possible to obtain an optical element which ensures the surface precision required for the effective optical surface. In addition, even if a crack or distortion occurs at the time of cutting the gate, the gate is located away from the lens portion, thereby minimizing the probability of occurrence of the defect by the crack or distortion.

The air vent is located at the position diametrically opposite to the gate. This makes it possible for the injected resin to flow smoothly and improve the surface precision required for the effective optical surface.

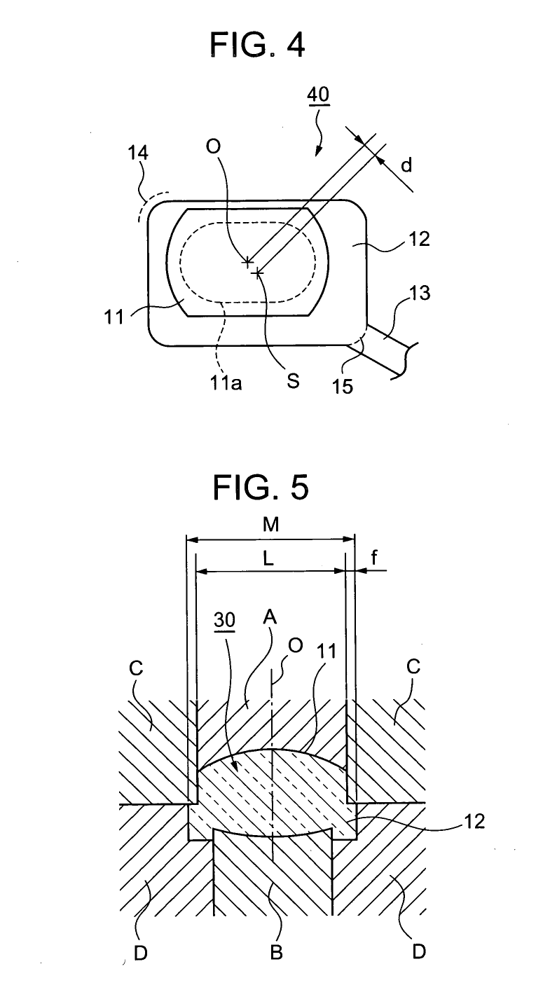

FIG. 4 is a plan view showing an optical element according to the fourth embodiment of the present invention. As in FIG. 3, the shape of the upper surface of a lens portion is different from a circle.

An optical element 40 shown in FIG. 4 is different from the optical element 30 shown in FIG. 3 in that a center S of an outer periphery formed by a flange portion 12 is shifted from an optical axis O of a lens portion 11 by a predetermined distance (distance d in FIG. 4).

In the shape such as that of the optical element 40 shown in FIG. 4, a gate 13 is located at one of the corners of the flange portion 12, which is farthest from the optical axis O. A degassing air vent is located at a position diametrically opposite to the gate 13 in the same manner as described above. Air vents may be formed at two remaining corners, as needed, in addition to the air vent diametrically opposite to the gate 13.

Even in the optical element 40 in which the shape of the upper surface of the lens portion 11 is different from a circle and the center S of the outer periphery formed by the flange portion 12 is shifted from the optical axis O of the lens portion 11, the gate is located at the corner farthest from the optical axis O. This makes it possible to obtain an optical element which ensures the surface precision required for the effective optical surface regardless of a small shape of the outer periphery. At the same time, when the air vent is located at the position diametrically opposite to the gate, the surface precision required for the effective optical surface can further be improved.

The gate is located at the position farthest from the lens portion. Even if a crack or distortion occurs at the time of cutting the gate, the gate is located away from the lens surface, thereby minimizing the probability of occurrence of the defect by the crack or distortion.

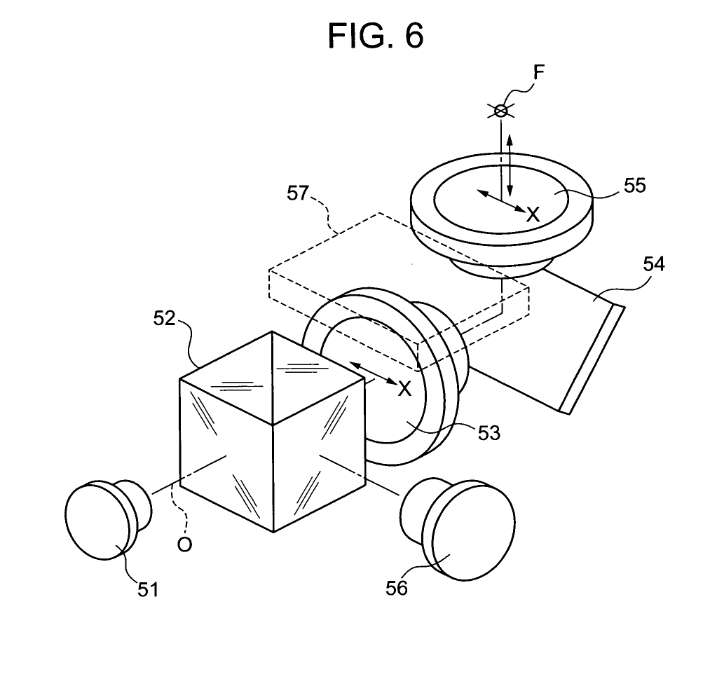

FIG. 5 is a sectional view taken along the line V-V in FIG. 3 in order to illustrate a mold which molds the optical element shown in FIG. 3. That is, FIG. 5 shows a lens surface, along the minor axis, of the lens portion whose upper surface shape is different from a circle.

Referring to FIG. 5, reference symbol A denotes a mold for forming the lens surface 11 of the optical element 30; B, a mold for forming the lens surface on the lower surface of the lens surface 11 of the optical element 30; C, a mold for forming the flange portion 12 at the inner surface of the mold A; and D, a mold for forming the flange portion 12 at the inner surface of the mold B. The mold A is inserted into a hole formed in the mold C, and the mold B is inserted into a hole formed in the mold D, thereby integrally forming the molds A, B, C, and D. The molds A, B, C, and D are separated by the boundary surface between the illustrated molds C and D, thereby removing the optical element 30.

As shown in FIG. 5, letting L be the width of the mold A which forms the lens surface 11 serving as the width of the minor-axis portion of the lens surface 11, and M be the width of the flange portion 12, the flange portion 12 is always present at the periphery of the lens surface 11. The optical element 30 is formed so that its size satisfies L<M. That is, even if the upper surface shape of the lens portion 11 is different from a circle, the flange portion 12 is present at the minor-axis portion of the lens portion 11.

The flange portion 12 is present at the periphery of the minor-axis portion of the lens portion 11. Even if the mold A is shifted in the mold C by an amount corresponding to the clearance or the mold A is attached while being rotated about the optical axis in the mold C, the molded lens portion 11 does not project from the flange portion 12. A width f of the flange portion 12 is preferably at least about 0.1 mm.

When the optical element described above is applied to an optical system which forms the optical pickup device shown in FIG. 6, the surface precision required for the lens surface can be ensured while the outer peripheral shape of the optical element is kept compact. The optical pickup device can be made compact without interfering with the layout of the actuator.

In each embodiment of the present invention described above, an optical element is applied as a collimator lens. However, the present invention is not limited to this. An optical element can be applied as an objective lens or the like, as a matter of course.

1. An optical element used for an optical pickup device which emits light onto an information recording medium to record and/or reproduce information, comprising:
a lens portion serving as an optical function surface; and
a flange portion whose outer periphery is formed rectangularly at a periphery of said lens portion,
wherein said optical element is molded by injecting a resin from a resin injection port located at a position corresponding to a corner of said flange portion in a mold.

2. An optical element used for an optical pickup device which emits light onto an information recording medium to record and/or reproduce information, comprising:
a lens portion serving as an optical function surface; and
a flange portion whose outer periphery is formed rectangularly at a periphery of said lens portion,
wherein a cutting portion of a resin injected from a resin injection port of a mold which molds said optical element is formed at one corner of said flange portion.

3. An element according to claim 1, wherein said mold which forms said optical element comprises an air vent at least at a position diametrically opposite to the resin injection port.

4. An element according to claim 2, wherein said mold which forms said optical element comprises an air vent at least at a position diametrically opposite to the resin injection port.

5. An element according to claim 3, wherein said optical element is molded in said mold whose resin injection port is located at a position of a corner farthest from an optical axis of said optical element so as to locate the optical axis of said optical element at a position different from a central portion of the outer peripheral shape of said flange portion.

6. An element according to claim 4, wherein said optical element is molded in said mold whose resin injection port is located at a position of a corner farthest from an optical axis of said optical element so as to locate the optical axis of said optical element at a position different from a central portion of the outer peripheral shape of said flange portion.

7. An element according to claim 1, wherein a front surface shape of said lens portion is formed to be different from a circle, and said flange portion is formed at a minor-axis portion of said lens portion.

8. An element according to claim 2, wherein a front surface shape of said lens portion is formed to be different from a circle, and said flange portion is formed at a minor-axis portion of said lens portion.

9. An optical pickup device comprising an optical element defined in claim 1.

10. An optical pickup device comprising an optical element defined in claim 2.

11. A device according to claim 9, wherein said optical element is used as a collimator lens.

12. A device according to claim 10, wherein said optical element is used as a collimator lens.

13. An optical element used for an optical pickup device which emits light onto an information recording medium to record and/or reproduce information, comprising:
a lens portion serving as an optical function surface; and
a flange portion whose outer periphery is formed in at least a peripheral portion of the lens portion at a sight in the direction of an optical axis,
an outer peripheral shape of said flange portion at a sight in the direction of an optical axis having at least a first linear portion and a second linear portion perpendicular to the first linear portion,
wherein the optical element is molded by injecting a resin from a position corresponding to a portion where the first and second linear portions cross each other.

14. An optical element used for an optical pickup device which emits light onto an information recording medium to record and/or reproduce information, comprising:
a lens portion serving as an optical function surface; and
a flange portion whose outer periphery is formed in at least a peripheral portion of the lens portion,
an outer peripheral shape of said flange portion at a sight in the direction of an optical axis having at least a first side extending in a first direction and a second side extending in a second direction and perpendicular to the first side,
wherein the optical element is molded by injecting a resin from a position corresponding to a portion where the first and second sides cross each other.
